(19) United States
(12) Patent Application Publication
(10) Pub. No.: US 2003/0221939 A1
(43) Pub. Date: Dec. 4, 2003

(54) Conveying apparatus

(76) Inventors: Erik van Wijngaarden, Hengelo (NL); Tom Delfos, Delft (NL); Wouter van den Berg, Voorburg (NL)

Correspondence Address: LARSON & TAYLOR, PLC, 1199 NORTH FAIRFAX STREET, SUITE 900, ALEXANDRIA, VA, 22314, US

(21) Appl. No.: 10/372,718

(22) Filed: Feb. 25, 2003

(30) Foreign Application Priority Data
Feb. 26, 2002 (EP) 02075721.7

(51) Int. Cl. B65G 41/00

(52) U.S. Cl. 198/860.2

(57) ABSTRACT

The present invention relates to a conveying apparatus comprising an endless conveyor, a frame for mounting the conveyor thereon, the frame being comprised of basic structural elements which extend in substantially three directions, viz. length, width and height, and of fixing elements, such as screws and nuts, wherein the basic structural elements comprise five types:

a longitudinal structural element,

a stabilizer element, slidably fitting into at least two longitudinal structural elements placed behind each other,

a transverse structural element,

a pillar element, and

a mounting block, for mounting and mutually positioning the longitudinal structural elements, the transverse structural elements, and the pillar elements, wherein at least the longitudinal structural elements and the transverse structural elements are generally lengthwise extending cylindrical material pieces, for instance hollow tubes or massive tubes, the cross section possessing a non-circularly symmetrical circumference, fitting with a close fit into corresponding recesses in the mounting blocks.

In particular, the tangent line to the circumference runs horizontally in at most two points thereof, so that the edges slope up/down gradually, substantially without notches.

With great advantage, such a frame is assembled from recurrent and readily expandable modules, such a frame has a high strength and stability, and is properly cleanable, specifically owing to the sloping edges and the close fit of the parts used.

The present invention relates to a conveying apparatus as indicated in the preamble of the main claim.

Such an apparatus is known, for instance, from U.S. Pat. No. 3,739,904, which discloses a frame suitable for supporting a conveyor such as a single or double chain. In respect of the second exemplary embodiment, it is mentioned that only a limited number of types of basic parts are deemed to be adequate to build up such a frame. However, such a frame is suitable for just a single conveyor chain.

For building up frames suitable for mounting and supporting a series of conveyor chains, for instance up to a number of 12, the support or spacer element indicated is altogether inadequate. Moreover, for conveying apparatus such as sorting machines for fruit, such as apples or citrus fruits, it will be necessary to assemble a frame having great strength in both longitudinal and transverse direction.

To that end, the invention provides a conveying apparatus as defined above, characterized in that the basic structural elements comprise five types:

a longitudinal structural element,

a stabilizer element, slidably fitting into at least two longitudinal structural elements placed behind each other,

a transverse structural element,

a pillar element, and

a mounting block, for mounting and mutually positioning the longitudinal structural elements, the transverse structural elements, and the pillar elements,

wherein at least the longitudinal structural elements and the transverse structural elements are generally lengthwise extending cylindrical material pieces, for instance hollow tubes or massive tubes, the cross section having a non-circularly symmetrical circumference, fitting with a close fit into corresponding recesses in the mounting blocks.

With great advantage, the frames can not only be built up with relatively few standard parts, but also, and especially so, such frames can be steplessly expanded using the very same parts, to any desired width Such a standardization renders multiple molds redundant. Moreover, the non-circularly symmetrical cross sections offer a great strength and stability to the frames, and the effect of turning moments as a result of possible imbalance through vibrations and skew will be considerably reduced.

According to a further exemplary embodiment, the apparatus according to the invention is characterized in that the tangent line to the circumference mentioned runs horizontally in at most two points thereof.

This means that these structural elements have a single highest and a single lowest point, having between these only, or substantially so, ascending/descending edges. A major advantage of this is that those material pieces can be kept clean very well, for instance by hosing them down, because they do not include any horizontal material surfaces on which detergent or dirt residues will be left behind. Moreover, products that are being conveyed with the conveyors but fall off en route will never be left behind on a horizontal surface. It is noted that the horizontal tangent lines mentioned permit notches but that, in view of the above, sharp slits and notches are undesirable. It is precisely the gradual upward/downward slope of the edges that improves the possibility of cleaning the elements and keeping them clean.

In further embodiments, the apparatus according to the invention is characterized in that the longitudinal structural elements, the transverse structural elements and the pillar elements have the same cross sectional circumference, that the circumference is a square, where the tangent line to a line section includes an angle of about 45° with the horizontal, and that the basic structural elements furthermore comprise a sleeve element fitting about the longitudinal structural elements, and with an outer rim therebetween, and furthermore fitting into a corresponding recess in the mounting blocks.

Further details and particulars of the invention will be elucidated with reference to the accompanying drawing, in which

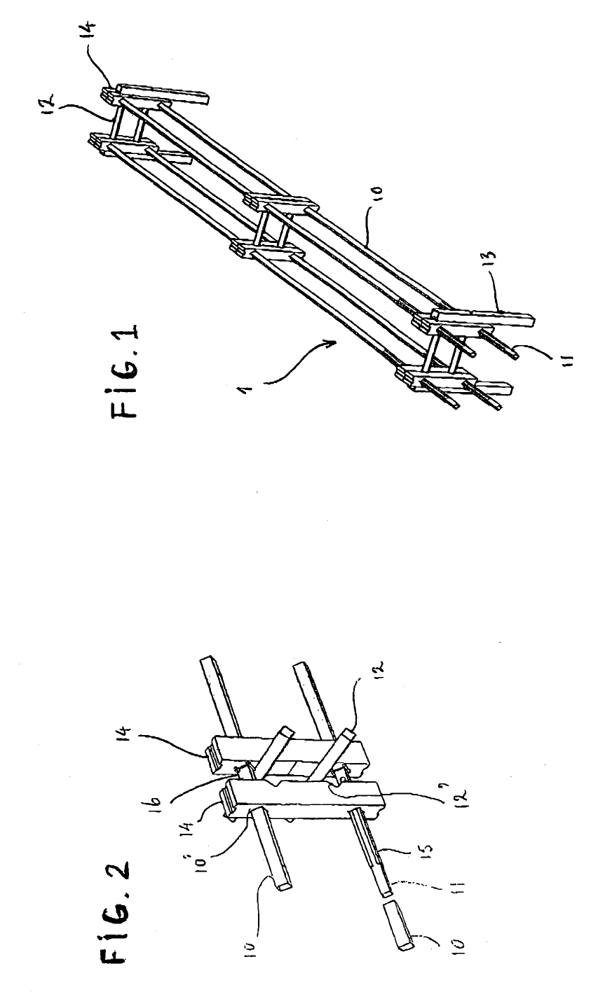

FIG. 1 is an isometric view of a frame according to the invention, and

FIG. 2 is an isometric view of a detail of such a frame, with the elements shown disassembled.

In the figures, the same parts have been given the same numbers.

In FIGS. 1 and 2, a frame 1 has been assembled from five main types of structural elements, viz. longitudinal structural elements 10, stabilizer elements 11, transverse structural elements 12, pillar elements 13, and mounting blocks 14.

The above-mentioned strength and stability are provided by the application of a square cross-sectional material circumference. The tubes are disposed at the above-mentioned angle of approximately 45°. The recesses required for that purpose in the mounting blocks are holes 10′ and V-shaped notches 12′.

In FIG. 2 it is indicated how two blocks 14, to be regarded as halves for receiving transverse structural elements 12, at least clampingly embrace these elements after fixation. If necessary, further fixation of these elements 12 in the blocks 14 can take place. Blocks 14 and elements 13 can be fixed in any manner customary for a skilled person. For instance, the blocks 14 can be mutually fixed with, for instance, screw/nut connections, and the pillar elements 13 with the blocks 14 through hole/screw/nut connections. In general, a single type of block is provided, for instance as shown in FIG. 2. However, blocks with several recesses, viz. notches and holes, may be desirable for particular types of conveying apparatus and thus furnish greater strength and stability. It is further noted that the slots shown in FIG. 2 at the top and bottom of the blocks are not essential to the present invention. It will be clear to anyone skilled in the art that such top and bottom surfaces will be utilized for mounting chain frames or chain guides.

Of due importance is the choice of suitable materials: sufficiently strong, and properly cleanable For instance, the blocks are made of plastic, such as polypropylene, and the tubes are made of stainless steel. For special applications, there are many other possibilities in this field of the art.

The shape of the mounting blocks will preferably be selected such that as great a symmetry as possible is obtained and the blocks can be used in several orientations. Preferably, the recesses, i.e. the holes 10′ and the notches 12′ are symmetrical with respect to a plane or axis.

To provide sufficient strength in the longitudinal direction, the stabilizer elements 11 can be fittingly slid into the longitudinal structural elements. To obtain more robustness and sealing, sleeve elements 15 of suitably chosen corresponding cross-sectional circumference can be used. These possess an outer rim 16, for instance halfway, of a circumference such that the ends of longitudinal structural elements 10 slid over them terminate on opposite sides of the rim 16 and this rim moreover fits into a recess intended for the purpose in each block 14. What is not indicated is that the sleeve elements can be so long that they can snap, by an inner edge, around the ends of a stabilizer element.

In a highly advantageous manner, the longitudinal and transverse structural elements 10, 12 will consist of the same tube material. A further highly advantageous possibility is to manufacture the pillar elements 13 from this same tube material as well. Supply, storage and use of such elements can thus be simplified considerably.

Standard lengths in this field of material supplies are, for instance, 6 m. In FIG. 1 it can be seen how, for instance, longitudinal structural elements 10 of a length of 6 m can be assembled to form modules of a length of 12 m, with blocks used at every 6 m, and pillar elements mounted after every 12 m. In the transverse direction, any desired width can be readily and advantageously chosen by utilizing parts of this 6 m. For the manufacture of sorting machines, for instance for fruit in packing stations, this is a major advantage because each station has different requirements and facilities. It specifically facilitates fitting them into spaces intended for the purpose.

In the exemplary embodiment represented, hollow tubes having a square cross-sectional circumference are used It will be clear to anyone skilled in the art that many variants are possible. To be considered here, besides cross sections such as rectangles or hexagons, are H-shaped massive sections having substantially obtuse angles while avoiding the use of sharp notches. The shape of the mounting blocks will preferably be selected such that a highest possible symmetry is obtained and the blocks can be used in several orientations. For the sake of completeness, it is mentioned that generally the geometry of the cylindrical circumference mentioned is such that the cross section can be any possible curve, such as the H sections, square, hexagonal, and also oval.

It will be clear to anyone skilled in the art that small modifications of what has been mentioned and described above should be understood to fall within the scope of protection of the appended claims.

1. A conveying apparatus comprising an endless conveyor, a frame for mounting the conveyor thereon, the frame being comprised of basic structural elements which extend in substantially three directions, viz. length, width and height, and of fixing elements, such as screws and nuts, characterized in that
the basic structural elements comprise five types:
a longitudinal structural element,
a stabilizer element, slidably fitting into at least two longitudinal structural elements placed behind each other,
a transverse structural element,
a pillar element, and
a mounting block, for mounting and mutually positioning the longitudinal structural elements, the transverse structural elements, and the pillar elements,
wherein at least the longitudinal structural elements and the transverse structural elements are generally lengthwise extending cylindrical material pieces, for instance hollow tubes or massive tubes, the cross section possessing a non-circularly symmetrical circumference, fitting with a close fit into corresponding recesses in said mounting blocks.

2. An apparatus according to claim 1, characterized in that the tangent line to said circumference runs horizontally in at most two points thereof.

3. An apparatus according to claim 1 or 2, characterized in that the longitudinal structural elements, the transverse structural elements and the pillar elements have the same cross sectional circumference.

4. An apparatus according to claim 1 or 2, characterized in that the circumference is a square, while the tangent line to a line section includes an angle of approximately 45° with the horizontal.

5. An apparatus according to any one of the preceding claims, characterized in that
the basic structural elements further comprise a sleeve element, fitting about the longitudinal structural elements, and with an outer rim therebetween, and furthermore fitting into a corresponding recess in said mounting blocks.
